(19) United States
(12) Patent Application Publication
(10) Pub. No.: US 2004/0018127 A1
(43) Pub. Date: Jan. 29, 2004

(54) Wafer bias drive for plasma source

(75) Inventors: Maolin Long, Guangzhou (CN); Richard Parsons, Phoenix, AZ (US); Wayne L. Johnson, Phoenix, AZ (US)

Correspondence Address: Dale S. Lazar, Pillsbury Winthrop LLP, 1600 Tysons Boulevard, McLean, VA, 22102, US

(73) Assignee: Tokyo Electron Limited, Tokyo (JP)

(21) Appl. No.: 10/458,801

(22) Filed: Jun. 11, 2003

Related U.S. Application Data
(63) Continuation of application No. PCT/US01/51642, filed on Dec. 12, 2001.
(60) Provisional application No. 60/256,387, filed on Dec. 19, 2000.

(51) Int. Cl. B01J 19/08

(52) U.S. Cl. 422/186.04; 422/186.29

(57) ABSTRACT

A segmented chuck provides uniform processing of a workpiece (e.g., a wafer) with a plasma in a process chamber. The segmented chuck includes a segmented electrode having a plurality of sub-electrodes where the sub-electrodes are electrically isolated from one another by insulating connections and the segmented electrode defines a process surface that is adapted to receive the workpiece. The segmented chuck also includes a plurality of RF drivers for driving the sub-electrodes with RF biases, where the RF biases couple the workpiece with the plasma in the process chamber. By allowing the workpiece to be placed on the chuck, the coupling between the plasma and the workpiece is enhanced. By allowing the sub-electrodes to be independently driven by RF drivers, more uniform processing can be achieved with larger workpieces.

This is a continuation of International Application No. PCT/US01/51642, filed on Dec. 2, 2001, and which, in turn, claims benefit of U.S. Provisional Application, No. 60/256,387, filed Dec. 19, 2000, the contents of both of which are incorporated herein in their entirety.

### BACKGROUND OF THE INVENTION

1. Field of Invention

The present invention relates to plasma processing and more particularly to a system having a segmented electrode for use in plasma processing.

2. Description of Related Art

As the dimensions of the features in Integrated Circuits (IC's) have shrunk over recent years, the requirements for uniformity of processing have tightened significantly. At the same time, the nominal size of a wafer has grown from 6 inches in diameter to 8 inches and is currently reaching 12 inches (300 mm). As a result, the requirements for tighter process uniformity must be maintained over a significantly larger area. However, present tools for reactive ion etching have difficulty maintaining the process uniformity necessary even for today's requirements, which are substantially less stringent than those anticipated for the future.

The increasing demands for smaller feature geometries and larger silicon wafers have put increasing pressure on plasma processing equipment manufacturers for tighter processing control over larger areas. The plasmas used for the processing, however, tend to be non-uniform, especially over large areas. In order to have more uniform processing, it is necessary to be able to modify or otherwise control the plasma locally.

Approaches to uniform plasma processing include systems with segmented electrodes and with non-segmented electrodes. In particular, the use of a segmented electrode can enable more degrees of freedom for controlling the plasma. In general, however, systems with a segmented electrode avoid placement of a workpiece on the segmented electrode, and, as a result, the RF coupling of the workpiece with the plasma is degraded. Typically these systems utilize a single RF source for driving the segments, possibly with phase differences, and so the ability to control the process to maintain uniformity is substantially limited.

### SUMMARY OF THE INVENTION

The present invention utilizes a segmented chuck for processing a workpiece with a plasma in a process chamber. According to an embodiment of the present invention, the segmented chuck includes a segmented electrode having a plurality of sub-electrodes where the sub-electrodes are electrically isolated from one another and the segmented electrode defines a process surface that is adapted to receive the workpiece. The segmented chuck also includes a plurality of RF drivers for driving the sub-electrodes with RF biases, where the RF biases couple the workpiece with the plasma in the process chamber.

The process surface may be substantially planar for ease in positioning the workpiece, and a pin lift assembly may be incorporated into the segmented chuck for loading and unloading of the workpiece. Each sub-electrode may be identified uniquely with a corresponding RF driver so that each sub-electrode can be independently driven. Further, each RF driver may be independently controlled by a control unit that generates RF driver inputs.

A chuck enclosure may contain the segmented electrode and the RF drivers. Alternatively, the RF drivers may be connected by RF transmission lines to a chuck enclosure that contains the segmented electrode.

The optional incorporation of an optical sensor (e.g., a camera system) that measures process data during plasma processing enables greater control for process uniformity and process endpoint by using the process data to determine the RF driver inputs.

### BRIEF DESCRIPTION OF THE DRAWINGS

These and other objects and advantages of the invention will become more apparent and more readily appreciated from the following detailed description of the exemplary embodiments of the invention taken in conjunction with the accompanying drawings, where:

FIG. 1 shows a cutaway view of a segmented chuck with internal RF bias power supplies according to an embodiment of the present invention;

FIG. 2 shows a schematic detail of an embodiment of RF driver components according to the present invention;

FIG. 3 shows a cutaway view of a segmented chuck with external power supplies according to an embodiment of the present invention;

FIG. 4 shows another schematic detail of an embodiment of RF driver components according to the present invention;

FIG. 5 shows another schematic detail of an embodiment of RF driver components according to the present invention;

FIG. 6 shows an embodiment of a system for controlling process endpoint and uniformity in an inductively coupled reactor according to an embodiment of the present invention;

FIG. 7 shows another embodiment of a system for controlling process endpoint and uniformity in a capacitively coupled reactor according to an embodiment of the present invention;

FIG. 8 is a process block diagram of a control circuit for controlling process endpoint and uniformity according to an embodiment of the present invention;

FIG. 9 shows an illustration of endpoint detection according an embodiment of the present invention; and

FIG. 10A shows a characteristic spectrometer measurement and

FIG. 10B shows a corresponding endpoint detection according to an embodiment of the present invention.

### DETAILED DESCRIPTION OF EXEMPLARY EMBODIMENTS

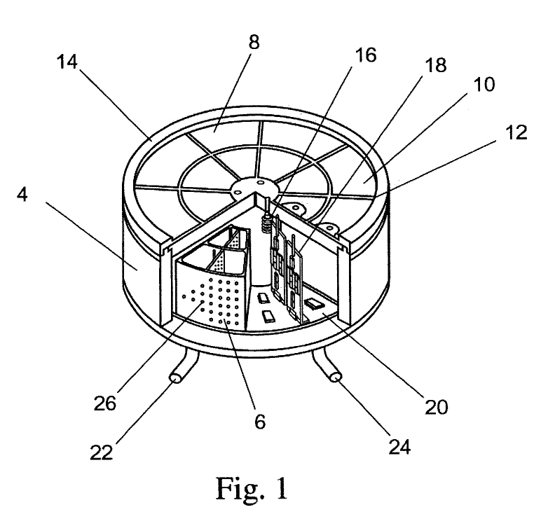

A segmented chuck 2 according to an embodiment of the present invention is shown in FIG. 1. The chuck 2 includes a chuck enclosure 4 that contains all of the chuck components. Additionally, an RF enclosure 6 provides for RF shielding of the chuck 2 and the components contained therein. A dielectric or semiconductor focus ring 14 is provided on the peripheral edge of the upper end of the chuck 2 as standard practice in plasma processing systems. The focus ring 14 consists of an insulating or semiconducting material suitably designed using conventional practices known in the art to aid with the plasma processing at the periphery of the workpiece placed on the chuck 2.

The chuck 2 includes a segmented electrode 8 with sixteen sub-electrodes 10; however, any suitable subdivision may be employed. Insulators 12 are provided between the sub-electrodes 10 to provide electrical isolation so that the sub-electrodes can be independently driven. The insulator between electrodes can have a low dielectric constant, to minimize capacitive coupling, and for mechanical properties suitable to withstand the stress of heating.

A lift pin assembly 16 is included to enable the convenient loading and unloading of a workpiece (e.g., a wafer ) on the chuck 2. Corresponding to each of the sub-electrodes 10, RF driver units 18 are located relatively close to the sub-electrodes 10 to provide close coupling. For each sub-electrode 10, RF control unit 20 provides the control function for the corresponding RF driver unit 18. The RF control unit 20 takes processing information from an external computer (or external process control electronics) and uses that data to drive the RF drivers 18 appropriately to achieve the desired process endpoint and uniformity.

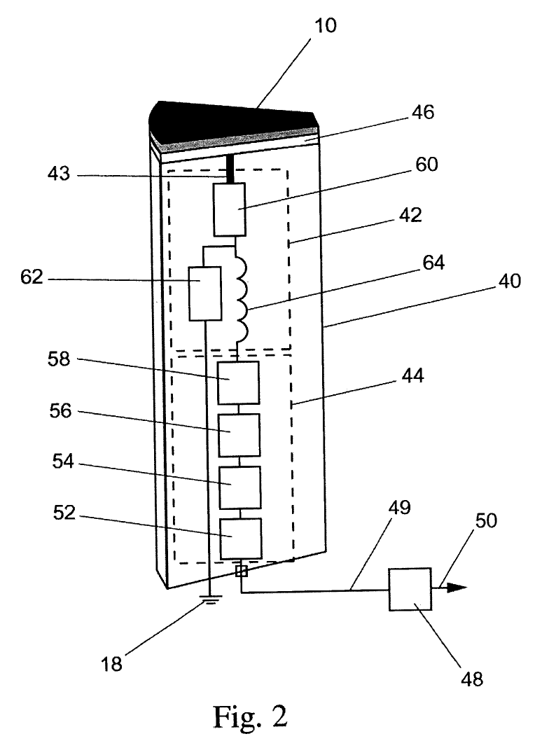

FIG. 2 shows a schematic detail of an embodiment of the RF driver unit 18, which can be arranged below a sub-electrode 10 and within a grounded RF enclosure 40. The RF driver unit 18 includes a match network 42 connected to an RF bias power supply 44. The match network 42 is connected by an RF link 43 to the sub-electrode 10 through a sub-electrode insulator 46. In fact, the output end of variable capacitor C1 may be directly connected to the sub-electrode 10. The RF control unit 48 is connected via a transmission line 49 (or multiple transmission lines) to at least one RF bias power supply 44. The RF control unit 48, which typically includes a master oscillator from which the RF signal is derived for application to the sub-electrode 10, receives input from an external computer 50 (or external process control electronics). Collectively the match network 42, the RF bias power supply 44 and the RF control unit 48 (plus their connections) make up the RF driver components necessary to drive the sub-electrode 10.

The RF bias power supply 44 includes a phase shifter 52, an RF amplifier 54, a circulator 56 for dumping power including power reflected at the sub-electrode 10 or received power due to coupling with adjacent sub-electrodes through the plasma, and a dual-directional coupler 58 for sensing forward and reflected power. The match network 42 is designed to match impedance by a combination of circuits including a first capacitor 60, a second capacitor 62 and an inductor 64. The design principles associated with this embodiment of the RF driver are described further in co-pending Provisional U.S. Patent Application No. 60/192,508, filed Mar. 28, 2000, and entitled METHOD AND APPARATUS FOR CONTROLLING POWER DELIVERED TO A MULTIPLE SEGMENT ELECTRODE, which application is incorporated by reference herein.

By including components of the match network 42 and the RF bias power supply 44 within the chuck 2, this embodiment advantageously enhances the coupling of the RF power and the plasma. However, since considerable heat is generated in the operation of the match network 42 and the RF bias power supply 44 and dissipated in the chuck 2, it is necessary to provide for adequate cooling of the chuck assembly 2. This is provided for by means of suitable connections for coolant inflow 22 and coolant outflow 24 together with suitable perforations 26 where needed internally in the chuck assembly 2.

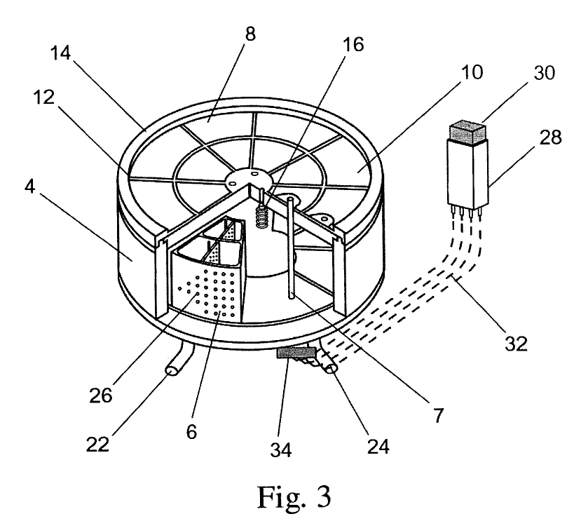

The present invention enables local control of the plasma parameters by use of a segmented chuck 2 with separate, independent RF bias to each of the segments 10. This concept is applicable to wafer processing systems that utilize capacitively coupled plasmas as well as inductively coupled plasmas. In the embodiment shown in FIG. 1, the RF bias power supply 44 and match network 42 are incorporated into the chuck 2 itself, thereby permitting close coupling of the RF bias power supply 44 to the sub-electrode 10. Alternatively, an external RF bias power supply may be remotely located and connected to the individual chuck segments by means of appropriate co-axial cables and matching networks, as shown in the second embodiment illustrated in FIG. 3.

In FIG. 3, a segmented chuck 52 includes many of the same components as the chuck 2 of FIG. 1 including a chuck enclosure 4 that contains all of the chuck components, a segmented electrode 8 with sixteen sub-electrodes 10, a dielectric focus ring 14 for plasma processing operations, and a lift pin assembly 16 for automatic loading and unloading of a workpiece with the chuck 52. As in the embodiment shown in FIG. 1, suitable connections are provided for coolant inflow 22 and coolant outflow 24 together with suitable perforations 26 where needed internally in the chuck assembly 52.

In FIG. 1 the RF driver unit 18 together with a protective RF enclosure 6 are included with the chuck enclosure 4. In the chuck 52 of FIG. 3, an RF bias power supply 28 and RF control unit 30 are located remotely from the chuck enclosure 4. The RF bias power supply 28 is connected to the sub-electrode 10 by means of one or more RF transmission lines 32, one or more matching networks 34, and through the enclosure 4 to the sub-electrode 10 by an RF link 7. In this way, hardware components to support the RF functionality need not be included in the chuck enclosure 4. The RF control unit 30 performs the same function as the RF control unit 20 in the embodiment of FIG. 1 but is located remotely together with the RF bias power supply 28. For each sub-electrode 10 an RF control unit 30 provides the control function for the corresponding RF bias power supply 28. Since, the RF bias power supply 28 and the RF control unit 30 are located remotely, the segmented electrodes 8 are driven through coaxial cables 32, and matching networks 34 are used to match the impedance of the cables 32 and the segmented electrodes 10.

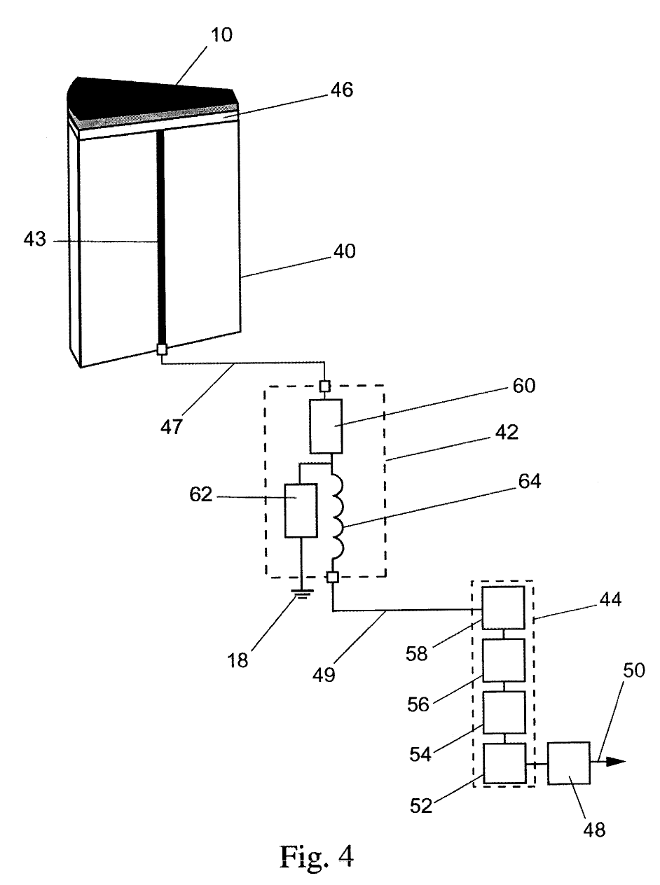

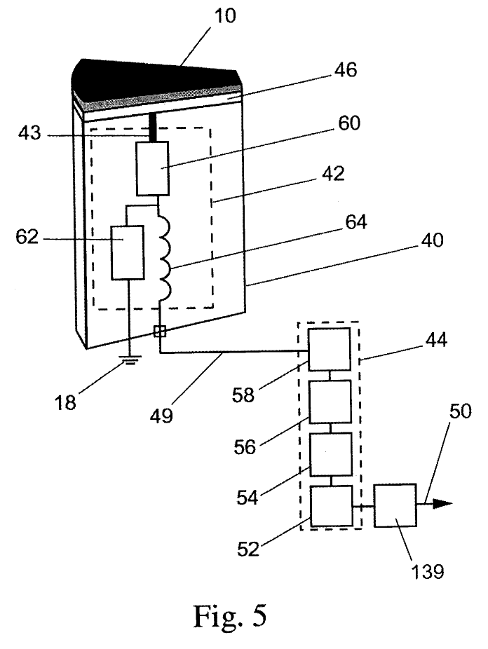

FIG. 4 shows a schematic detail of an embodiment of the RF driver components that are configured to drive the sub-electrode 10 of FIG. 3. The elements shown in FIG. 4 are similar to those shown in the schematic detail of FIG. 2. However, in FIG. 4 only the RF link 43, which connects to the sub-electrode 10 through the sub-electrode insulator 46, is disposed within the grounded RF enclosure 40. The match network 42, the RF bias power supply 44, and the RF control unit 48 are located remotely from the enclosure 40. Transmission line 49 connects RF bias power supply 44 to match network 42. Transmission line 47 connects match network 42 to RF link 43. Other variations in configurations of the RF driver components are also possible. FIG. 5 shows a modification of FIG. 4 where the match network 42 and the RF link 43 are disposed within the grounded RF enclosure 40. As before, the output of capacitor C1 may be directly connected to the sub-electrode 10 without the need for RF link 43.

The segmented chuck 2 of FIG. 1 (or similarly the segmented chuck 52 of FIG. 3) may be used as part of a larger system for plasma processing. An exemplary embodiment of a segmented electrode with independent RF drivers that are used to control a capacitively-coupled plasma is described in co-pending Provisional U.S. Patent Application No. 60/185,069, filed Feb. 25, 2000, and entitled MULTI-ZONE RF ELECTRODE FOR FIELD/PLASMA UNIFORMITY CONTROL IN CAPACITIVE PLASMA SOURCES, which application is incorporated by reference herein. This co-pending application describes control based on measurements related to the RF field distribution with sensors such as, for example, a scanning Langmuir probe, a scanning optical emission spectrometer (OES) or an interferometer.

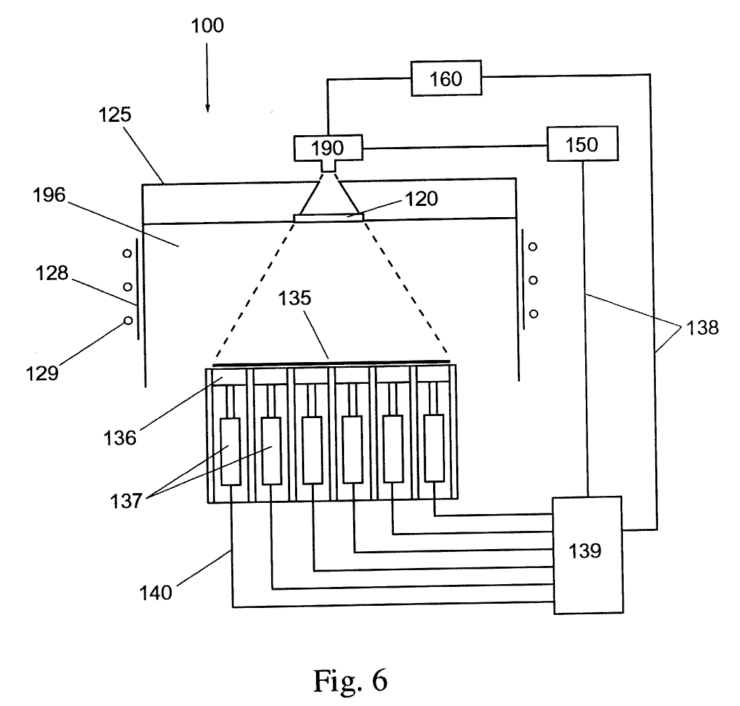

FIG. 6 shows an embodiment of an Electrostatically Shielded RF (ESRF) plasma processing system 100 with an inductively coupled plasma according to the present invention. The system 100 includes a process chamber 125 with an RF induction coil 129 and an electrostatic shield 128, together with the segmented chuck 136 of the present invention with a wafer 135 disposed on the chuck 136. Optical radiation from a plasma 196 is viewed by a sensor 190 that is fitted with a wide-angle lens 110 such that the sensor 190 views the plasma 196 over all parts of the wafer 135 through an optical window 120. The sensor 190 may be a LES 1200 Thin Film Metrology Sensor (Leybold Inficon), capable of in-situ measurement of thin film etch or deposition rate, rate uniformity, end point uniformity and plasma optical emission over the entire wafer. The optical window 120 is provided to maintain the vacuum integrity of the chamber 125 while permitting the sensor 190 to view the plasma 196 during all phases of the process. The output of the sensor is fed to a first computer 150 and a second computer 160, which check for the end point of the process and monitor the process uniformity, respectively. The computers 150 and 160 feed data to the RF control unit 139 by the control lines 138. The RF control unit 139, via control lines 140, controls the signals fed to the RF drivers 137 located in the segmented wafer chuck 136. The process is terminated when the first computer 150 detects that the end-point of the process has been reached by turning off each of the RF drivers 137 at the appropriate time.

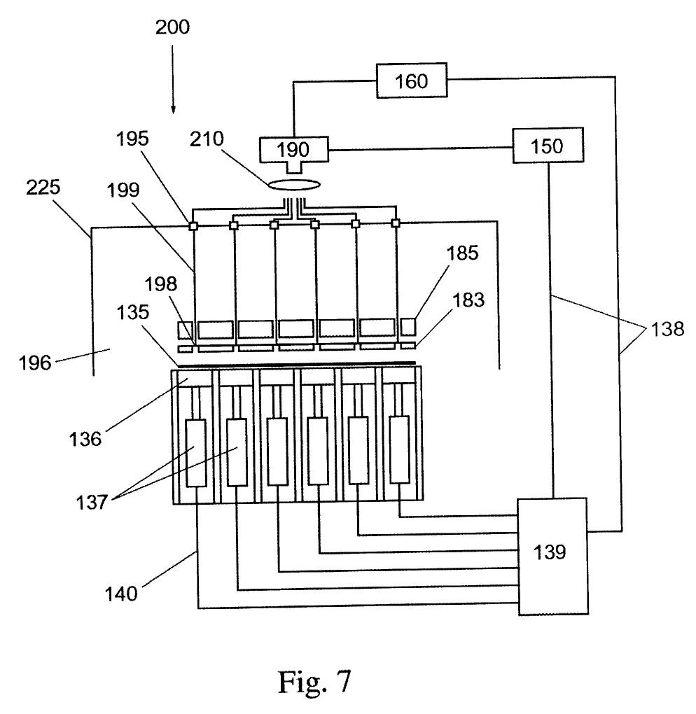

FIG. 7 shows an embodiment of a plasma processing system 200 with a capacitively coupled plasma according to the present invention. The system 200 consists of a process chamber 225 that is fitted with a capacitively coupled RF electrode 183 and gas injection system 185. The wafer to be processed 135 is held on the segmented chuck 136. The chamber is also fitted with a series of optical fibers 199 which are located so that they permit viewing of the wafer 135 through openings 198 in the electrode 183 and gas injection system 185. The fibers 199 and openings 198 are arranged so that each fiber 199 views the portion of the wafer 135 served by an individual segment of the segmented wafer chuck 136. The optical fibers 199 are fed out of the process chamber 125 by means of optical vacuum feed-throughs 195. The light from the plasma 196 fed out by the optical fibers 199 is collected by a lens 210 and focussed into a sensor 290. The sensor 290 may be a CCD (charge-coupled device) array or a CID (charge-injected device) array. The output of the sensor 290 is then fed to the computers 150 and 160 which check for end point and monitor process uniformity, respectively. The computers 150 and 160 feed data to the RF control unit 139, which in turn drives the RF drivers 137 located in the segmented wafer chuck 136. When the first computer 150 senses the end-point, the RF drivers 137 are turned off at the appropriate time.

In general, the sensors 190, 290 each include hardware such as a light detector (e.g., CCD array, CID array, photo-multiplier tube, etc.) and a light dispersion mechanism (e.g., filter, monochromator, spectrometer, etc.). These components as well as suitable processors for the computers 150, 160 are known in the art for endpoint detection. Examples are described in U.S. Pat. No. 5,888,337 (entitled “Endpoint detector for plasma etching”) and U.S. Pat. No. 4,357,195 (entitled “Apparatus for controlling a plasma reaction”), which patents are incorporated herein by reference.

With the embodiments of FIGS. 6 and 7, any arrangement of RF drivers and RF control units may be employed, housed within the chuck, outside the chuck or partially in and partially outside of the chuck.

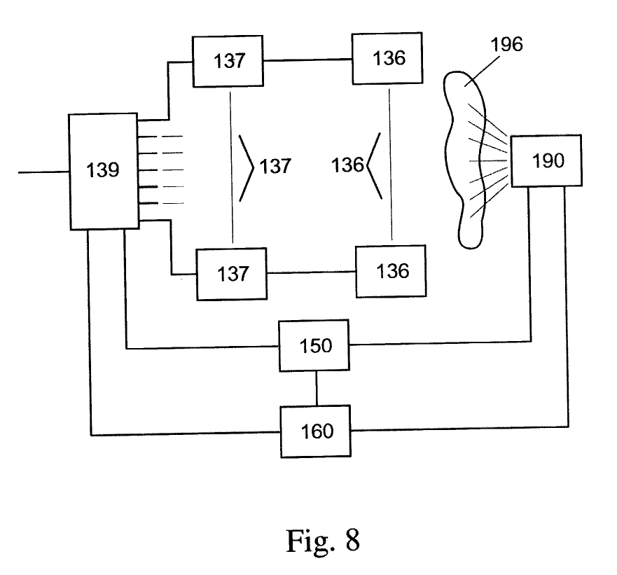

FIG. 8 shows a block diagram illustrating a method of measurement and control according to the present invention for the system 100 illustrated by the embodiment shown in FIG. 6 (and similarly for the system 200 shown in FIG. 7). The sensor 190 observes and measures the optical signal from the plasma 196 associated with each of the segments 136a . . . n of the segmented wafer chuck. The output of the sensor 190 which contains the appropriate data on the uniformity of the process is then fed to the computers 150 and 160, which process the information and send appropriate control signal to the RF control unit 139. Drive signals from the RF control unit 139 are sent to the individual RF drivers 137a . . . n, which in turn drive the individual segments of the segmented wafer chuck 136a . . . n. In this manner, closed-loop control of the processing associated with each segment of the segmented wafer chuck may be achieved, assuring uniformity of processing of the wafer.

In the embodiment shown in FIG. 8, the sensor 190 carries out a spatial resolution of the spectral emissions by extracting data corresponding to individual chuck segments 136a-136n. As illustrated in FIG. 6, the sensor 190 captures a field of view across the wafer 135, and a spatial resolution of spectral data can be made by local averaging of pixels to determine local emissions spectra corresponding to a specific chuck segment 136a-136n. Then data from each segment 136a-136n can be used independently to determine the control input for its corresponding RF driver 137a-137n. Alternatively, a more complex control scheme may be implemented by coupling the spatially varying emissions spectra across the chuck segments 136 with the inputs to the spatially distributed RF drivers 137.

The embodiment shown in FIGS. 7 illustrates an alternative mechanism for the spatial resolution of spectral emissions according to the present invention. In the ESRF system 100 of FIG. 6, the sensor 190 captures a field of view across the wafer 135 to determine averages of local emissions spectra by averaging pixels. By contrast in the system 200 of FIG. 7, the sensor 290 captures already localized emissions spectra from the optical fibers 199. The subsequent processing of data in either case is qualitatively similar so that the processing illustrated in FIG. 8 applies similarly.

Details for alternative embodiments of spatially resolved optical emission monitoring and control according to the present invention are described in co-pending Provisional U.S. Patent Application 60/193,250, filed Mar. 30, 2000, and entitled OPTICAL MONITORING AND CONTROL SYSTEM AND METHOD FOR PLASMA REACTORS, which application is incorporated by reference herein.

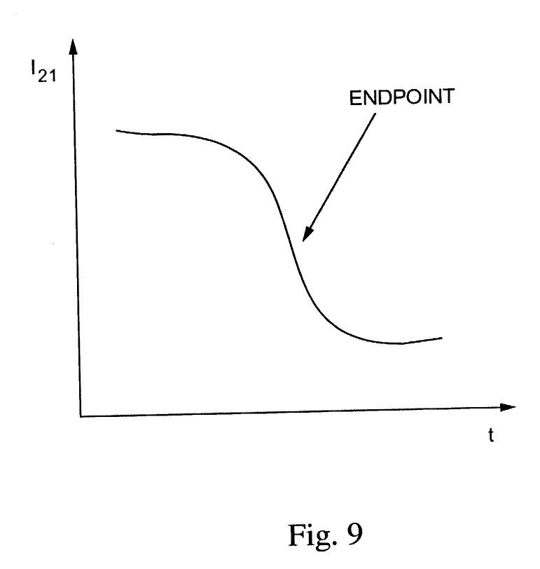

End point detection via optical emission spectroscopy, which is carried out by the first computer 150, is well known to those skilled in the art. For example, one well-known method of determining endpoint is to use a variable monochromator and a photomultiplier for sensitive detection of the emitted radiation. The grating in the monochromator may be set to allow the passage of a very narrow band of light (for simplicity, a single wavelength) to pass through the output aperture and fall on the light detection device. The wavelength is usually chosen to be consistent with the plasma induced emission line of a specific etch reactant or product (e.g. CO for oxide etch, etc.). The intensity of this line is monitored and when the endpoint layer is reached and the chemistry suddenly changes, the intensity of the light received at this chosen wavelength changes. The software is designed to recognize this change in intensity so that, as illustrated in FIG. 9, when the change in intensity with time exceeds a critical value endpoint is detected.

Another approach to endpoint detection includes monitoring the light intensity at two wavelengths and recording the ratio (or some mathematical manipulation thereof) of the two intensities. For instance, one wavelength is chosen for a specie whose concentration decays at endpoint and a second wavelength is chosen for a specie whose concentration increases at endpoint. Therefore, the ratio gives improved signal to noise. As the IC device sizes have decreased and the exposed etched area correspondingly decreases, more sophisticated endpoint detection schemes have arisen, wherein data is sampled at thousands of wavelengths and data extraction techniques such as Principal Component Analysis, etc. are used to extract the endpoint signal. One such patent utilizing this technique is U.S. Pat. No. 5,288,367 (entitled “End-point detection”), which patent is incorporated herein by reference.

One shortcoming of conventional implementations for endpoint detection (cf. U.S. Pat. No. 4,357,195) is that the optical system typically looks across the wafer and therefore it provides no information regarding the spatial variability of the etch endpoint. For example, due to process non-uniformities, the center of the wafer may reach endpoint before the edge of the wafer. A spatial resolution of the endpoint signal is particularly useful for a segmented upper or lower electrode where the process can be affected locally when endpoint is reached at one location while it permits the process to continue locally at another region that has not reached endpoint. For instance, when endpoint is reached at the wafer center, power to the center electrode may be decreased and/or shut off. One may then continue to control the power to the outer electrodes until endpoint is reached at the edge of the wafer.

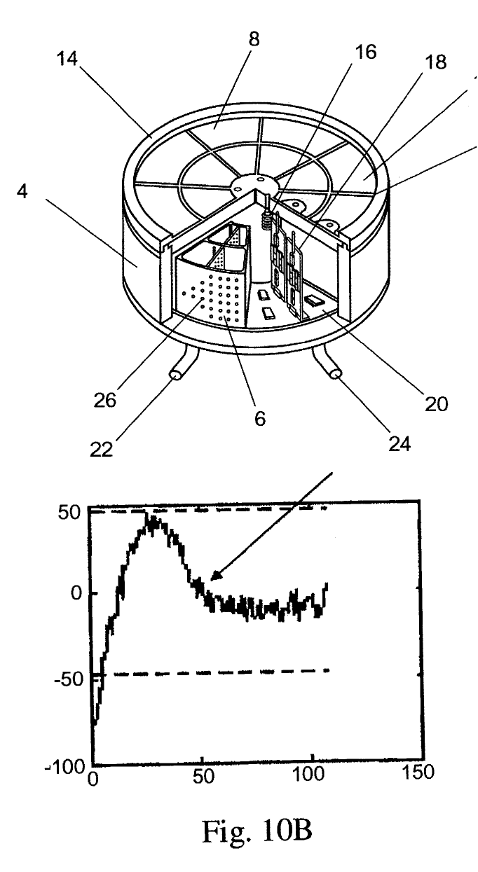

According to the present invention, an optical spectrometer may be implemented to record an emission spectrum during an etch process similar to that shown in FIG. 10A. At the sampling rate of the spectrometer, a spectrum may be recorded as a function of time throughout the process. In doing so, an endpoint signal may be derived using for example the PCA technique and the endpoint may be detected. FIG. 10B presents an example of a principal component used as an endpoint signal wherein the endpoint location is noted (the displayed signal is plotted against time during an etch process wherein the inflection point designates the endpoint of the process). Therefore, a separate sensor (e.g., a separate spectrometer) may be employed to view a different region above the wafer (cf. FIG. 7). From each sensor, the emission spectrum is recorded onto a data processor (e.g., the first computer 150), where any of a number of techniques (such as single wavelength analysis, multi-wavelength analysis, PCA, etc.) may be used to derive an endpoint signal for a corresponding specific region on the wafer. Frequently, the detection algorithm can be characterized as a search algorithm that terminates when an inflection point is found to determine the endpoint as illustrated in FIGS. 9 and 10B. When endpoint is achieved for a particular location, the primary computer (e.g., RF control unit 139) for controlling the process, including for example process gas flow and RF power, can be alerted to decrease and/or shut-down power to the sub-electrode proximate the wafer region in which endpoint is achieved. Spatial control of the endpoint detection can eliminate the adverse effects of over-etch.

Uniformity control, which is carried out by the second computer 160, is accomplished analogously to the endpoint detection described above but with a different spectral focus. The same hardware may be used to view the emission spectrum at different locations above the wafer. And, for example, the light intensity for CF₂ emission may be compared at different locations above the wafer (cf. FIG. 10A). In those regions where the CF₂ concentration is weak, the RF power to the sub-electrode proximate the region may be increased or decreased to affect a change in the local CF₂ concentration towards the concentration at other locations above the wafer. A database assembled from tests performed a priori can be utilized to guide the control scheme (for instance, a predictor corrector algorithm) wherein the effect of the RF power on the CF₂ concentration has been studied and trends have been realized. Conversely, the control scheme can weakly change the RF power (i.e. plus or minus 20W) in either direction (increase or decrease), evaluate the respective change in the CF₂ concentration as a result of the specific change in the RF power, and then choose the appropriate direction and extrapolate the magnitude of change for adjusting the CF₂ concentration to be equal to other locations above the wafer.

Therefore, in one mode of operation directed towards process uniformity, the sensor 190 may be utilized to monitor the spatial distribution of the etch rate. For example, if the etch rate is less at the exterior of the wafer, then the RF power delivered to an outer segment can be increased. Alternatively, if the etch rate is less at the wafer center, then the RF power delivered to an inner segment may be increased. In essence, the RF power delivered to regions of the processing plasma is adjusted to compensate for the spatial non-uniformity in the etch rate. Prior to wafer processing, a blanket wafer may be used to tune the segmented electrode segment power distribution formula, i.e., amplitude, phase, and frequency. Furthermore, the plasma optical emission for various species may be monitored in order to optimize the etch (or deposition) chemistry.

The present invention thereby enhances the uniformity of wafer processing in a plasma processing system. By introducing multiple RF sources (e.g., one for each sub-electrode 10 of the segmented electrode 8), the present invention adds complexity over conventionally used devices but enables greater fine-tuning of process control as illustrated in FIG. 8. As the dimensions of desired workpieces become more challenging (e.g., 300 mm wafers with 70 nm geometries), requirements for processing are likely to exceed the capabilities of conventional devices.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A segmented chuck for processing of a workpiece with a plasma in a process chamber, comprising:
a segmented electrode having a plurality of sub-electrodes, the sub-electrodes being separated from one another, and the segmented electrode defining a process surface that is adapted to receive the workpiece; and
a plurality of RF drivers for driving the sub-electrodes with RF biases, wherein the RF biases couple the workpiece with the plasma in the process chamber.

2. A segmented chuck as claimed in claim 1, wherein the process surface is substantially planar.

3. A segmented chuck as claimed in claim 2, further comprising:
a lift-pin assembly that is integrated with the process surface, wherein the lift-pin assembly operates to load and to unload the workpiece with respect to the process surface.

4. A segmented chuck as claimed in claim 1, wherein each sub-electrode is uniquely identified with a corresponding RF driver.

5. A segmented chuck as claimed in claim 4, further comprising a plurality of control units, the control units operating to determine RF driver inputs, the control units being adapted to transmit the RF driver inputs to the RF drivers, wherein the RF drivers control the RF biases based on the RF driver inputs.

6. A segmented chuck as claimed in claim 1, further comprising a chuck enclosure that contains the segmented electrode and the RF drivers.

7. A segmented chuck as claimed in claim 1, wherein each RF driver comprises a match network and a RF bias power supply.

8. A segmented chuck as claimed in claim 7, further comprising a chuck enclosure that contains the segmented electrode and at least one match network.

9. A segmented chuck as claimed in claim 7, wherein each RF bias power supply comprises a phase shifter, a circulator, amplifier, and a phase shifter.

10. A segmented chuck as claimed in claim 1, further comprising:
a chuck enclosure that contains the segmented electrode; and
a plurality of RF transmission lines that connect the RF drivers to the segmented electrode, wherein the RF drivers and the control units are exterior to the chuck enclosure.

11. A system for plasma processing of a workpiece, comprising:
a process chamber;
a plasma source, the plasma source operating to generate a plasma in the process chamber;
a segmented chuck having a segmented electrode and a plurality of RF drivers, the segmented electrode having a plurality of sub-electrodes, the sub-electrodes being separated from one another, the segmented electrode defining a process surface that is adapted to receive the workpiece, and the RF drivers operating to drive the sub-electrodes with RF biases that couple the workpiece with the plasma;
a sensor, the sensor having visual access to the process surface through an optical interface in the process chamber, and the sensor operating to determine process data; and
a control system, the control system operating to generate RF driver inputs from the process data, the control system being adapted to receive the process data from the sensor and to transmit the RF driver inputs to the RF drivers, wherein the RF drivers control the RF biases in response to the RF driver inputs.

12. A system as claimed in claim 11, wherein the process surface is substantially planar.

13. A system as claimed in claim 12, further comprising:
a lift-pin assembly that is integrated with the process surface, wherein the lift-pin assembly operates to load and to unload the workpiece with respect to the process surface.

14. A system as claimed in claim 11, wherein each sub-electrode is uniquely identified with a corresponding RF driver.

15. A system as claimed in claim 14, further comprising a plurality of control units, the control units operating to determine RF driver inputs, the control units being adapted to transmit the RF driver inputs to the RF drivers, wherein the RF drivers control the RF biases based on the RF driver inputs.

16. A system as claimed in claim 11, further comprising a chuck enclosure that contains the segmented electrode and the RF drivers.

17. A system as claimed in claim 11, further comprising:
a chuck enclosure that contains the segmented electrode; and
a plurality of RF transmission lines that connect the RF drivers to the segmented electrode, wherein the RF drivers and the control units are exterior to the process chamber.

18. A method for plasma processing of a workpiece, comprising:
loading the workpiece onto a process surface in a plasma chamber, the process surface being defined by a segmented electrode, the segmented electrode including a plurality of sub-electrodes that are separated from one another;
generating a plasma in the process chamber;
coupling the workpiece with the plasma for plasma processing by using RF drivers to generate RF biases at the sub-electrodes, the RF drivers and the segmented electrodes being included in a segmented chuck;
determining process data from the plasma processing;
generating RF driver inputs from the process data;
adjusting the RF biases of the RF drivers based on the RF driver inputs; and
unloading the workpiece from the process surface after plasma processing.

19. A method as claimed in claim 18, wherein each sub-electrode is uniquely identified with a corresponding RF driver.

20. A method as claimed in claim 19, wherein the act of generating RF driver inputs from process data includes determining a process uniformity condition from the process data.

21. A method as claimed in claim 19, wherein the act of generating RF driver inputs from process data includes determining a process endpoint condition from the process data.
